(19) United States
(12) Patent Application Publication
(10) Pub. No.: US 2026/0129586 A1
(43) Pub. Date: May 7, 2026

(54) SYSTEMS, METHODS, AND NON-TRANSITORY PROCESSOR-READABLE MEDIA FOR POWER CONTROL FOR UPLINK TRANSMISSIONS

(71) Applicant: ZTE CORPORATION, Shenzhen (CN)

(72) Inventors: Ke YAO, Shenzhen (CN); Bo GAO, Shenzhen (CN); Yang ZHANG, Shenzhen (CN); Xiaolong GUO, Shenzhen (CN); Meng MEI, Shenzhen (CN)

(73) Assignee: ZTE CORPORATION, Shenzhen (CN)

(21) Appl. No.: 19/438,995

(22) Filed: Jan. 2, 2026

Related U.S. Application Data
(63) Continuation of application No. PCT/CN2023/107509, filed on Jul. 14, 2023.

(51) Int. Cl. H04W 52/14; H04B 7/0456; H04W 52/18

(52) U.S. Cl. CPC H04W 52/146; H04B 7/0456; H04W 52/18

(57) ABSTRACT

A wireless communication method includes determining, by a wireless communication device, a precoder for an uplink transmission, determining, by a wireless communication device, power for the uplink transmission according to a scaling factor, wherein the scaling factor is determined according to a power capability report, and sending, by a wireless communication device to a network, the uplink transmission according to the precoder and/or the power for the uplink transmission.

### CROSS-REFERENCE TO RELATED APPLICATION

This application claims the benefit of priority under 35 U.S.C. § 120 as a continuation of PCT Patent Application No. PCT/CN2023/107509, filed on Jul. 14, 2023, the disclosure of which is incorporated herein by reference in its entirety.

### TECHNICAL FIELD

The disclosure relates generally to wireless communications and, more particularly, to systems, methods, and non-transitory processor-readable media for implementing power control for uplink transmissions.

### BACKGROUND

New Radio (NR) technology of Fifth Generation (5G) mobile communication systems continuously improve the quality and user experience of higher quality wireless communication. To achieve such end, Customer-Premises Equipment (CPE) such as Fixed Wireless Access (FWA) support high capability UE and improve Uplink (UL) quality. For example, up to 8 Transmission (Tx) (e.g., antenna ports) for UL transmission can be implemented to further improve higher quality wireless communication.

### SUMMARY

In some arrangements, systems, methods, apparatuses, and non-transitory computer-readable media allow determining, by a wireless communication device, a precoder for an uplink transmission, determining, by a wireless communication device, power for the uplink transmission according to a scaling factor, wherein the scaling factor is determined according to a power capability report, and sending, by a wireless communication device to a network, the uplink transmission according to the precoder and/or the power for the uplink transmission.

In some arrangements, systems, methods, apparatuses, and non-transitory computer-readable media allow receiving, by a network from a wireless communication device, an uplink transmission, wherein the uplink transmission is transmitted using a precoder and/or a power determined by the wireless communication device, wherein the power is determined according to a scaling factor, the scaling factor is determined according to a power capability report.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 is a diagram illustrating an example cellular communication network, in accordance with some arrangements.

FIG. 2 illustrates block diagrams of an example base station and an example user equipment device, in accordance with some arrangements.

FIG. 3A is a diagram illustrating UE Tx antenna architecture 2Tx that is non-coherent, in accordance with some arrangements. FIG. 3B is a diagram illustrating UE Tx antenna architecture 2Tx that is coherent, in accordance with some arrangements.

FIG. 4A is a diagram illustrating UE Tx antenna architecture 4Tx that is non-coherent, in accordance with some arrangements. FIG. 4B is a diagram illustrating UE Tx antenna architecture 4Tx that is partially-coherent, in accordance with some arrangements. FIG. 4C is a diagram illustrating UE Tx antenna architecture 4Tx that is full-coherent, in accordance with some arrangements.

FIG. 5A is a diagram illustrating UE Tx antenna architecture 6Tx that is non-coherent, in accordance with some arrangements. FIG. 5B is a diagram illustrating UE Tx antenna architecture 6Tx that is partially-coherent, in accordance with some arrangements. FIG. 5C is a diagram illustrating UE Tx antenna architecture 6Tx that is full-coherent, in accordance with some arrangements.

FIG. 6A is a diagram illustrating UE Tx antenna architecture 8Tx that is non-coherent, in accordance with some arrangements. FIG. 6B is a diagram illustrating UE Tx antenna architecture 8Tx that is partially-coherent, in accordance with some arrangements. FIG. 6C is a diagram illustrating UE Tx antenna architecture 8Tx that is full-coherent, in accordance with some arrangements.

FIG. 7 is a table illustrating an example relationship between the indication of a number of groups and corresponding indication of TPM1 or rank, according to various arrangements.

FIG. 8 is a flowchart diagram illustrating an example method for implementing power control for UL transmissions, according to various arrangements.

FIG. 9 is a table illustrating an example relationship between PA capability type, the lowest PA capability with high priority, and the lowest PA capability with low priority, according to various arrangements.

FIG. 10 is a table that illustrates the relationship between the identifier (e.g., G0, G1, etc.) and corresponding port group supporting the full power, according to various arrangements.

FIG. 11 is a table that illustrates the relationship between the identifier (e.g., G0, G1, G2, G3, G4, etc.) and corresponding port group supporting the full power, according to various arrangements.

FIG. 12 is a table that illustrates the relationship between the identifier (e.g., G0, G1, G2, G3, G4, G5, G6, G7, etc.) and corresponding port group supporting the full power, according to various arrangements.

FIG. 13 is a table illustrating an example relationship between PA capability type (e.g., G0, G1, G2, G3, G4, G5, G6, G7, G8, G9, etc.), and lowest PA Capability reported by TPMI(s) or matrix(es), according to various arrangements.

FIG. 14 is a table illustrating an example relationship between ports (ZP or NZP) and layers (e.g., layers 0, 1, and 2), according to various arrangements.

FIG. 15 is a table illustrating an example relationship between ports (ZP or NZP) and layers (e.g., layers 0, 1, and 2), according to various arrangements.

FIG. 16 is a table illustrating an example relationship between ports (ZP or NZP) and layers (e.g., layers 0, 1, and 2), according to various arrangements.

FIG. 17 is an example of a precoding matrix with the coefficient of 1/\sqrt{8}, according to various arrangements.

FIG. 18 is a table that illustrates example relationships between the rank, values of (L1, L2) for all layers in an antenna group, and values of (L1, L2) for layers split across 2 antenna groups, according to some arrangements.

FIG. 19 is a table that illustrates example relationships between the rank, values of (L1, L2, L3, L4) for all layers in an antenna group, and values of (L1, L2, L3, L4) for layers split across 4 antenna groups, according to some arrangements.

FIG. 20 illustrates a 2 layers 4Tx precoding matrix and a 3 layers 4Tx precoding matrix with coefficient with a factor 1/\sqrt{N_{g}} used to determine a precoding matrix for 8Tx, according to various arrangements.

FIG. 21 is an 8Tx precoding matrix using a uniform coefficient determined by N_{NZP}=2, according to some arrangements.

FIG. 22 is an 8Tx precoding matrix using a uniform coefficient determined by Lₘₐₓ=3, according to some arrangements.

FIG. 23 is a table illustrating an example relationship between joint coded indication bit field mapped to indices, rank (rank restriction), a first port group, and a second port group.

FIG. 24 is a table illustrating an example relationship between joint coded indication bit field mapped to indices, rank (rank restriction), a first port group, a second port group, a third port group, and a fourth port group.

FIG. 25A is a table illustrating a precoding matrix W for single-layer transmission using four antenna ports with transform precoding disabled, according to some arrangements.

FIG. 25B is a table illustrating a precoding matrix W for two-layer transmission using four antenna ports with transform precoding disabled, according to some arrangements.

FIG. 25C is a table illustrating a precoding matrix W for three-layer transmission using four antenna ports with transform precoding disabled, according to some arrangements.

FIG. 25D is a table illustrating a precoding matrix W for four-layer transmission using four antenna ports with transform precoding disabled, according to some arrangements.

FIG. 25E is a table illustrating a precoding matrix W for single-layer transmission using two antenna ports, according to some arrangements.

FIG. 25F is a table illustrating a precoding matrix W for two-layer transmission using two antenna ports with transform precoding disabled, according to some arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

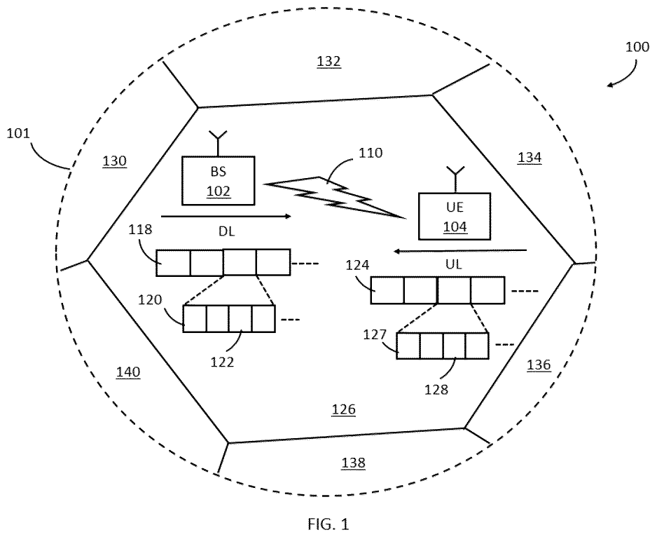

FIG. 1 illustrates an example wireless communication system 100, in accordance with an arrangement of the present disclosure. The wireless communication system 100 may be any wireless network, such as a cellular network or a narrowband Internet of things (NB-IoT) network. The system 100 includes a Base Station (BS) 102 and a User Equipment (UE) 104 that can communicate with each other via a communication link 110 (e.g., a wireless communication channel), and a cluster of cells 126, 130, 132, 134, 136, 138 and 140 overlaying a geographical area 101. In FIG. 1, the BS 102 provides wireless communications and services within the geographic boundary of cell 126, and the UE 104 is located within the area 101. Each of the other cells 130, 132, 134, 136, 138 and 140 may include at least one BS (such as the BS 102) operating at its allocated bandwidth to provide adequate radio coverage to its intended users.

For example, the BS 102 can operate at an allocated channel transmission bandwidth to provide adequate coverage to the UE 104. The BS 102 and the UE 104 may communicate via a downlink radio frame 118 and an uplink radio frame 124, respectively. Each radio frame 118 or 124 may be further divided into sub-frames 120 or 127, respectively, which may include data symbols 122 or 128, respectively. The BS 102 and UE 104 can be examples of communication nodes generally, which can practice the methods disclosed herein. Such communication nodes may be capable of wireless and/or wired communications, in accordance with various arrangements of the present solution.

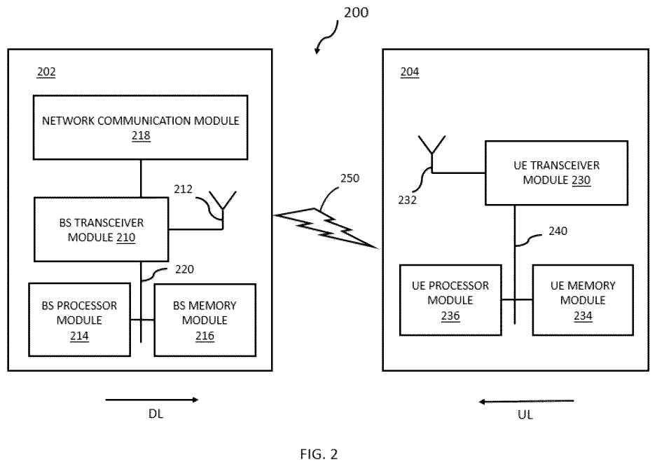

FIG. 2 illustrates a block diagram of an example wireless communication system 200 for transmitting and receiving wireless communication signals, e.g., Orthogonal Frequency Division Multiplexing (OFDM)/Orthogonal Frequency Division Multiple Access (OFDMA) signals, in accordance with some arrangements of the present solution. The system 200 may include components and elements configured to support known or operating features that need not be described in detail herein. In some arrangements, system 200 can be used to communicate (e.g., transmit and receive) data or signals in a wireless communication environment such as the wireless communication system 100 of FIG. 1. System 200 generally includes a BS 202 and a UE 204. The BS 202 is an example of the BS 102. The UE 204 is an example of the UE 104.

The BS 202 includes a BS transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

The system 200 may further include any number of modules other than the modules shown in FIG. 2. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some arrangements, the UE transceiver 230 may be referred to herein as an uplink transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some arrangements, the BS transceiver 210 may be referred to herein as a downlink transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some arrangements, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative arrangements, the UE transceiver 210 and the base station transceiver 210 are configured to support industry standards such as the Long Term Evolution (LTE) and emerging 5G, 6G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various arrangements, the BS 202 may be an gNB, evolved node B (eNB), a serving eNB, a target eNB, a femto station, or a pico station, for example. In some arrangements, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the arrangements disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some arrangements, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

In some arrangements, the UE 104 reports capability of a coherent level or a number of port group(s). In some arrangements, the BS 102 configures or indicates a coherent level or number of port group(s) (or a number of port group sets).

The coherent level reflects coherent capability among port groups. If 2 ports are coherent, the phase between the 2 ports can be controlled by the transmitter, e.g., the UE 104, when the 2 ports are transmit ports of the UE 104. If 2 ports are not coherent, the phase cannot be assumed to be controlled by the transmitter. For a UE 104 supporting more than 2 ports, some ports can be coherent, while some ports are not coherent. In this example, from perspective of UE 104, the UE 104 has partial coherent ports. For 8Tx (e.g., an 8-port UE), the coherent level can be full coherent which means all 8 ports are coherent, partial coherent 1 which means there are 2 (4Tx, or 4-port) groups, partial coherent 2 which means there are 4 (2Tx, or 2-port) groups, or non-coherent which means any ports are not coherent. Ports are coherent within a group, and ports are non-coherent among two different groups. The coherent level corresponds to a number of port groups. Full coherent level corresponds to 1 group, e.g., Ng=1, partial coherent 1 level corresponds to 2 groups, e.g., Ng=2, partial coherent 2 level corresponds to 4 groups, e.g., Ng=4, and non-coherent level corresponds to 8 groups, e.g., Ng=8.

For UE transmission (Tx) antenna architecture which includes for example 2Tx, 4Tx, 6Tx, and 8Tx, coherent Tx antenna ports are usually arranged to be cross-polarized. Tx antenna architectures with non-coherent, partial coherent, and full coherent capability are shown in FIGS. 3A-6C. In FIGS. 3A-6C, the one or more Tx antennas (each shown as “x”) within a dashed box are coherent.

FIG. 3A is a diagram illustrating UE Tx antenna architecture 2Tx that is non-coherent, in accordance with some arrangements. FIG. 3B is a diagram illustrating UE Tx antenna architecture 2Tx that is full-coherent, in accordance with some arrangements. UE Uplink 2Tx antenna port transmissions need only non-coherent and full-coherent antennas.

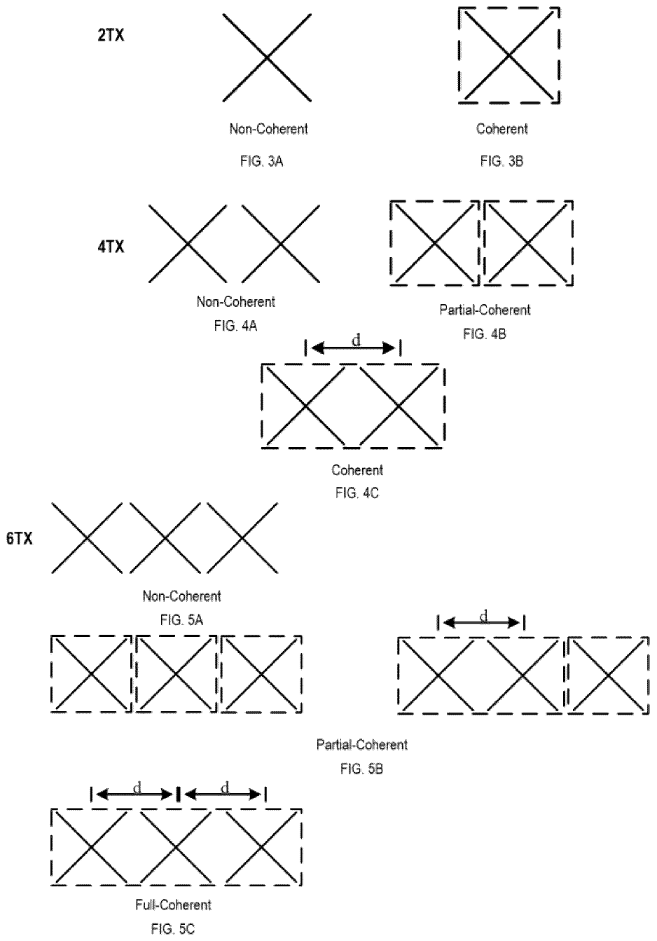

FIG. 4A is a diagram illustrating UE Tx antenna architecture 4Tx that is non-coherent, in accordance with some arrangements. FIG. 4B is a diagram illustrating UE Tx antenna architecture 4Tx that is partially-coherent, in accordance with some arrangements. FIG. 4C is a diagram illustrating UE Tx antenna architecture 4Tx that is full-coherent, in accordance with some arrangements. UE Uplink 4Tx antenna port transmissions need to use non-coherent, partial-coherent, and full-coherent antennas. For partial-coherent antennas, the combination {2,2} is shown.

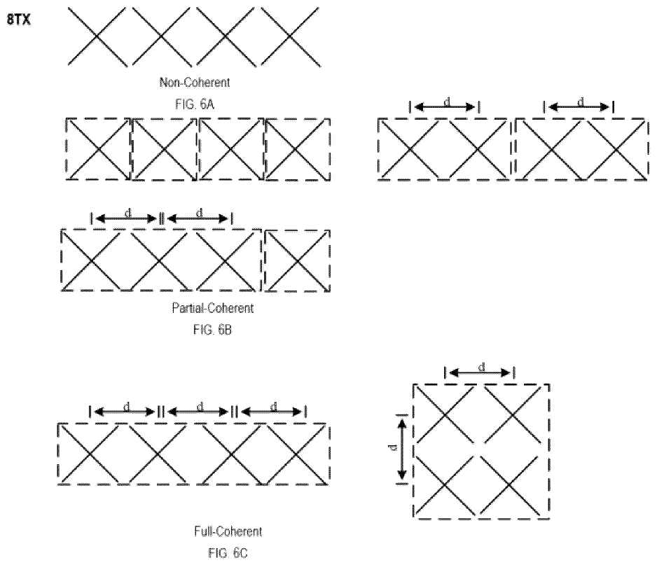

FIG. 5A is a diagram illustrating UE Tx antenna architecture 6Tx that is non-coherent, in accordance with some arrangements. FIG. 5B is a diagram illustrating UE Tx antenna architecture 6Tx that is partially-coherent, in accordance with some arrangements. FIG. 5C is a diagram illustrating UE Tx antenna architecture 6Tx that is full-coherent, in accordance with some arrangements. For partial-coherent antennas, combinations {2, 2, 2}, {4, 2} as shown can be considered.

FIG. 6A is a diagram illustrating UE Tx antenna architecture 8Tx that is non-coherent, in accordance with some arrangements. FIG. 6B is a diagram illustrating UE Tx antenna architecture 8Tx that is partially-coherent, in accordance with some arrangements. FIG. 6C is a diagram illustrating UE Tx antenna architecture 8Tx that is full-coherent, in accordance with some arrangements. For partial coherent antennas, combinations of {2, 2, 2, 2} (partial coherent 1), {4, 4} (partial coherent 1), {6, 2} as shown can be considered.

For coherent antennas, distance d between two groups of cross-polarization can be λ/2 or another value (e.g., K*λ, or another value for distributed antennas, such as Heterogeneous or UE aggregation), where λ is wavelength of the transmitted uplink signals. In some examples, each Tx beam is polarization-common. In some examples, a single phase value applies to at least one precoder of all antennas with the same polarization (e.g., per layer).

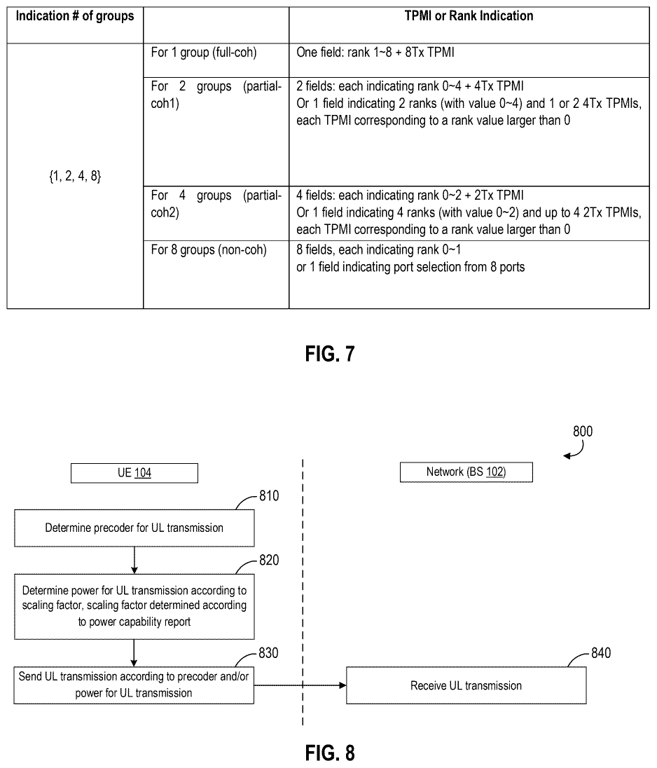

In some examples, the BS 102 indicates a precoder for a transmission by a joint-coded indication in a Downlink Control Information (DCI). The joint-coded indication can indicate rank information and precoding information to form a precoder. In some examples, the UE 104 receives coherent or number of port group(s) (or a number of port group sets) and the DCI, e.g., from a network (e.g., the BS 102), and determines a precoder for the transmission. The precoding information can be a set of parameter values, a Transmitted Precoding Matrix Indicator (TPMI) indicating a set of parameter values, or one or more TPMIs. Each TPMI corresponds to a non-zero rank. FIG. 7 is a table illustrating an example relationship between the indication of a number of groups (e.g., 1, 2, 4, or 8) and corresponding indication of TPMI or rank, according to various arrangements. Rank refers to a number of layers (e.g., Multiple Input Multiple Output (MIMO) layers).

FIG. 8 is a flowchart diagram illustrating an example method 800 for implementing power control for UL transmissions, according to various arrangements. The method 800 can be implemented using the system 100 or 200. At 810, the UE 104 determines a precoder for an UL transmission. At 820, the UE 104 determines power for the UL transmission according to a scaling factor. The scaling factor is determined according to a power capability report. At 830, the UE 104 sends to a network (e.g., the BS 102) the UL transmission according to the precoder and/or the power for the uplink transmission. At 840, the network (e.g., the BS 102) receives the UL transmission.

In some arrangements, the UE 104 determines a scaled power of the UL transmission according to a power scaling factor. For example, the UE 104 is scheduled, triggered, or configured a UL transmission by a network (e.g., the BS 102). The UE 104 can determine Power Control (PC) parameters in a predetermined method or according to power control parameters associated with the UL transmission. The PC parameters can include at least one of open loop power control parameters (e.g., target receiving power (P0), pathloss (PL) factor (alpha), and so on), closed loop power control parameters (e.g., closed loop power control process index, 1, and so on), or Path Loss Reference Signal (PL-RS) (e.g., a RS used for PL measurement) for the UL transmission. In some examples, PC parameters are predefined, such as closed loop ID 0, or the first PL-RS in the PL-RS list configured by the network to the UE 104. In some examples, PC parameters are associated with SRS Resource Indicator (SRI) values. An SRI value can be indicated for a UL transmission by network to UE 104, e.g., via scheduling information in DCI or Media Access Control (MAC) Control Element (CE) or RRC signaling. Then, the PC parameters for the UL transmission can be determined via SRI.

In some arrangements, the UE 104 determines a required power for a UL transmission according to the power control parameters related to the UL transmission.

In some arrangements, the required power of logarithmic format (having the unit of dBm) is transformed to a linear value of required power \hat{P}. The UE 104 determines a scaled power of the UL transmission by applying a power scaling factor s to the linear power of UL transmission \hat{P}.

In some arrangements, the method 800 includes determining, by the UE 104, a scaled power for the UL transmission by applying a scaling factor to a linear power of the uplink transmission. The scaling factor includes at least one of 1, N1/N, a value greater than N1/N, or a value less than 1. N1 is a number of Non-Zero-Power (NZP) ports of the uplink transmission. N is a number of ports of the UE 104 used for the UL transmission. In some examples, Nis the number of ports for the Sounding Reference Signal (SRS) resource which is indicated by the SRI field in a DCI which schedules or triggers the UL transmission or the SRI configured in RRC signaling. At least one of N1 or N is a positive integer. N1 is less than or equal to N.

In some arrangements, N is a maximum number of SRS ports supported by the UE 104 in one SRS resource. In some arrangements, N is a number of SRS ports, which is associated with an SRS resource indicated by an SRI field in a DCI format scheduling the UL transmission (e.g., the Physical Uplink Shared Channel (PUSCH) transmission) in the example in which two or more SRS resources are configured in the SRS-ResourceSet with usage set to “codebook,” two or more SRS resources are indicated by Type 1 configured grant, or the number of SRS ports is associated with the SRS resource if only one SRS resource is configured in the SRS-ResourceSet with usage set to “codebook”.

In some examples, the scaling factor is determined according to a power capability report from the UE 104 to the network (e.g., the BS 102). The power capability report can be determined by at least one of a first method, a second method, or a third method, e.g., for full power mode 2. In the method 800, the power capability report is sent by the UE 104 to the network (e.g., the BS 102). In some examples, the power capability report includes power capability for full power mode 2.

For the first method, the power capability of the UE 102 can be reported by the UE 102 per each port, or per port group, or for all ports of the UE 102. In the method 800, the power capability report includes power capability for one or more ports or one or more port groups of the UE 102, or for all ports of the UE 102.

In some arrangements, the power capability can be Power Amplifier (PA) capability, the lowest power capability, or the lowest PA capability. In the method 800, the power capability report includes power capability of at least one of PA capability, a lowest power capability, or a lowest PA capability.

In some arrangements, the power capability can include at least one of full power is supported, a power ratio over a full power, a power gap/offset compared with full power (note that full power refers to a maximum power), and so on. In the method 800, the power capability report indicates power capability of at least one of full power, a power ratio over full power, or a power gap compared with the full power. The power ratio is a ratio of a power level over a full power level of the UE 104 or a ratio of the power level over a maximum power of the UE 104. In some examples, the power ratio is a ratio of a power level over a full power level or over a maximum power of the UE. A UE can support full power if the UE uses all ports to transmit. For partial ports that are used to transmit data, some ports can support full power, and others may not. The power capability is a power level supported by the one or more NZP ports.

In some arrangements, the port as referred to herein can be a transmit antenna port of the antenna 232.

In some examples, PA capability report includes or represents PA configuration of the UE 104. In the example in which the UE 104 includes 8 Tx ports, the UE 104 does not support a large number of PA configurations. It is typical that the UE 104 can support 8 types of PA configurations.

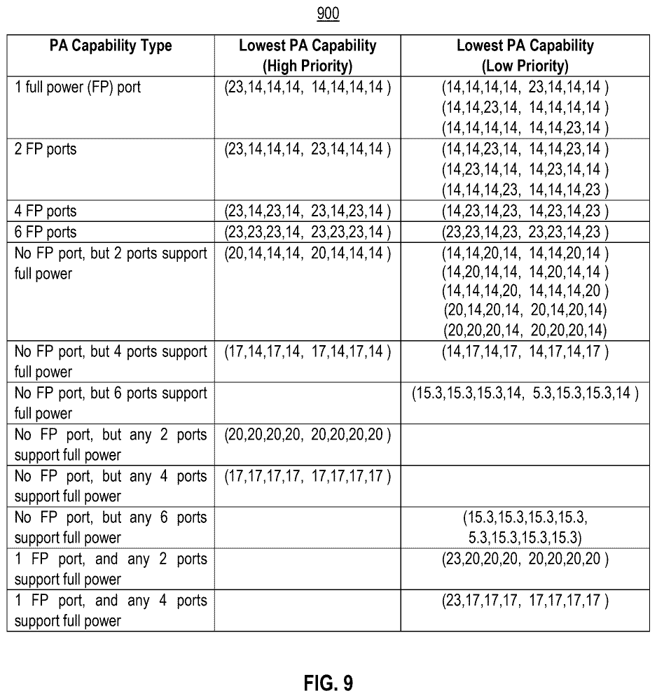

The UE 104 reports one lowest power capability from a predefined, predetermined, or a preconfigured list. The list includes two or more PA capabilities. FIG. 9 is a table 900 illustrating an example relationship between PA capability type, the lowest PA capability with high priority, and the lowest PA capability with low priority, according to various arrangements. As shown in table 900, PA capability can be indicated by a power level. For example, 23 represents 23 dBm for a corresponding port with full power capability for a power class 3 UE, 14 represents 14 dBm which is a lowest level for a PA for 8Tx ports, and any number less than 23 and greater than 14 represents a PA with neither full power nor lowest power. In the example in which the maximum power for the UE 104 is a number other than 23, e.g., 26, the number of 23 is replaced by 26, and 3 should be added to each number shown in the table 900.

PA capability can also be indicated by a power ratio compared with full power. In the example in which full power level is 23 dBm for the UE 104, the number of 23 in the table 900 can be replaced by a power ratio of 1, 20 in the table 900 can be replaced by a power ratio of ½, 17 in the table 900 can be replaced by ¼, and 14 in the table 900 can be replaced by ⅛. For example, (23, 14, 14, 14, 23, 14, 14, 14) in the table 900 can be replaced by (1, ⅛, ⅛, ⅛, 1, ⅛, ⅛, ⅛). The power level of dBm or the power ratio can be indicated by power offset compared with full power in dB. For example, (23, 14, 14, 14, 23, 14, 14, 14) in the in the table 900 can be replaced by (0, −9, −9, −9, 0, −9, −9, −9).

In some examples, the power level in dB or power ratio can support different power class UEs flexibly as compared to power level in dBm. One or more of power capabilities as shown in the table 900 can be used as the list. Note that high priority or low priority are general clarifications, and should not be a limitation for selection of PA capability.

For the second method, the power capability of the UE 102 can be reported according to Ng. In the method 800, the power capability report includes power capability is determined according to a number of port groups Ng. In some examples, details of power capability in third method can be reused for power capability in the second method.

In the method 800, the number of port groups includes each of numbers of port groups reported by the UE 104 to the network (e.g., the BS 102). The number of port groups is a largest number of port groups among the number of port groups reported by the UE 104 to the network. The number of port groups is a number of port groups configured or indicated by the network to the UE 104.

In some arrangements, the power capability report includes power capability for at least one of one or more first TPMI, one or more first matrices, or one or more first information, according to the number of port groups. In some arrangements, one of the one or more first TPMI corresponds to a number of transmit (Tx) ports, the number of Tx ports is same as the number of port groups. Each of the Tx ports corresponds to a number of ports in a port group corresponding to the number of port groups.

In some arrangements, one of the one or more first matrices corresponds to a number of Tx ports. The number of Tx ports is same as the number of port groups. Each of the Tx ports corresponds to a number of ports in a port group corresponding to the number of port groups.

In some arrangements, one of the one or more first information corresponds to a number of ports. Each port of the one of the one or more first information corresponds to a number of ports in a port group. The port group corresponds to the number of port groups.

In the example in which Ng=1, no ZP port exists. In other words, all ports are NZP ports. Thus, there is no need to report power capability.

In the example in which Ng=2, only port group selection codebooks (with ZP ports) need power capability report. In some examples, 2 values are used in a predetermined indication list to indicate which one port group can support full power. In some examples,

$$[ \begin{matrix}1 \\ 0\end{matrix} ] and [ \begin{matrix}0 \\ 1\end{matrix} ]$$

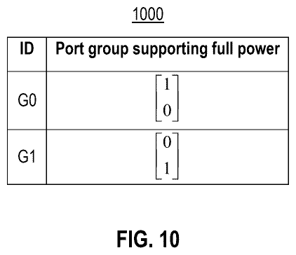

represent that the first and the second port group that support full power, respectively. Each element represents a port group, and a port group represents or includes 4 ports. FIG. 10 is a table 1000 that illustrates the relationship between the identifier (e.g., G0, G1, etc.) and corresponding port group supporting the full power, according to various arrangements. In some arrangements, the number of port groups is 2, the power capability report includes at least one of the power capability for a first port group (e.g., G0) or the power capability for a second port group (e.g., G1).

In some arrangements, the port combinations do not cover all possibilities, but only a limited number of port combinations. The standard of specification may need to support only a limited number of PA architectures, configurations, or settings. The power capability for a limited ports combination allows a flexibility of implementation of PA architectures, configurations, or settings in a UE, while not introducing a large burden for standardization. The index of the port or port groups described herein is only stated as example, and can be replaced by another index of ports or port groups. For example, if the number of port groups is 4 (e.g., Ng=4), the first, second, third, and fourth port groups can be mapped to another kind of port group indexing, e.g., the first, third, second, and fourth port groups respectively, or other kind of port group indexing. If the number of port(s) (groups) is 8 (e.g., Ng=8), the first, second, . . . , eighth port groups can be mapped to another kind of port group indexing, e.g., the first, third, second, fourth, fifth, seventh, sixth, eighth port groups respectively, or other kind of port group indexing.

In the example in which Ng=4, only port group selection codebook needs power capability report. In some examples, multiple values are used in a predetermined indication list to indicate which two or more port groups (with ZP ports) can support full power. In some examples,

$$[ \begin{matrix}1 \\ 0 \\ 0 \\ 0\end{matrix} ]$$

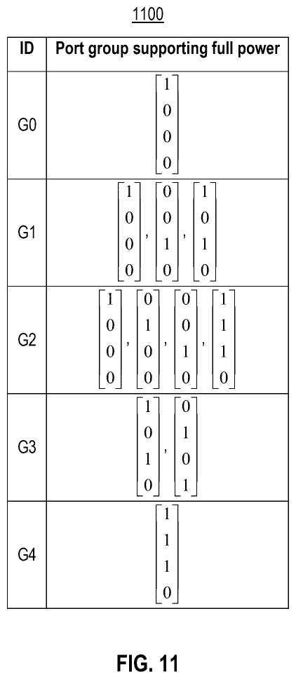

represents that the first port group supports full power. Each element represents a port group, and a port group represents or includes 2 ports. FIG. 11 is a table 1100 that illustrates the relationship between the identifier (e.g., G0, G1, G2, G3, G4, etc.) and corresponding port group supporting the full power, according to various arrangements. In some arrangements, the number of port groups is 4, and the power capability report includes at least one of 1) the power capability for a first port group (e.g., G0), 2) the power capability for the first port group and the power capability for a third port group (e.g., G1), 3) the power capability for the first port group, the power capability for a second port group, and the power capability for the third port group (e.g., G2), 4) the power capability for the first port group and the third port group and the power capability for the second port group and a fourth port group (e.g., G3), or 5) the power capability for the first port group, the second port group, and the third port group (e.g., G4).

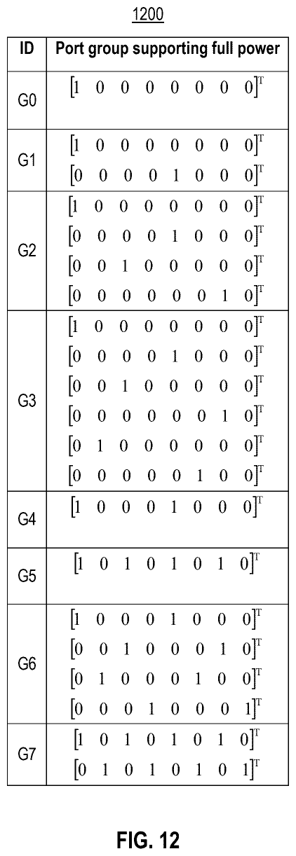

In the example in which Ng=8, only port group selection codebooks (with ZP ports) need power capability report. In some examples, multiple values are used in a predetermined indication list to indicate which one or more ports (groups) can support full power. In some examples, [1 0 0 0 0 0 0 0] T represents that the first port (group) support full power. Each element represents a port (or a port group). FIG. 12 is a table 1200 that illustrates the relationship between the identifier (e.g., G0, G1, G2, G3, G4, G5, G6, G7, etc.) and corresponding port group supporting the full power, according to various arrangements. In some arrangements, the number of port groups is 8, and each of the port group has one port, the power capability report includes at least one of 1) a power capability for a first port (e.g., G0), 2) the power capability for the first port, and the power capability for a fourth port (e.g., G1), 3) the power capability for the first port, power capability for a third port, power capability for a fifth port, and power capability for a seventh port (e.g., G2), 4) the power capability for the first port, power capability for a second port, the power capability for the third port, the power capability for the fifth port, power capability for a sixth port, and the power capability for the seventh port (e.g., G3), 5) the power capability for the first port and the fourth port (e.g., G4), 6) the power capability for the first port, the third port, the fifth port, and the seventh port (e.g., G5), 7) the power capability for the first port and the fifth port, the power capability for the second port and the sixth port, the power capability for the third port and seventh port, and the power capability for the fourth port and eighth port (e.g., G6), or 8) the power capability for the first port, third port, fifth port, and seventh port, and the power capability for the second port, the fourth port, the sixth port, and the eight port (e.g., G7).

Note that the notation [ ]^{T} represents transpose of a matrix [ ]. The column matrix in the examples can also be replaced by a row matrix with same elements which correspond to a set of ports.

For the third method, the power capability can be reported for at least one first TPMI or first precoding matrix. The power capability for other TPMIs can be determined according to the power capability reported for the at least one first TPMI. In the method 800, the power capability report includes power capability for at least one of one or more first TPMI, one or more first matrices, or one or more first information. The UE 104 determines power capability for at least one of a second TPMI or a second precoding matrix according to the at least one of the one or more first TPMI, the one or more first matrices, or the one or more first information.

In some examples, the first TPMI or the one layer precoding matrix can be one of codebooks for a UE 104, and is used to determine the power capability of the first TPMI or the one layer precoding matrix and the second TPMI or second precoding matrix.

In some examples, first TPMI or the one layer precoding matrix can be outside of (e.g., not within) the domain of the allowed codebooks for the UE 104, but is used to determine the power capability of other TPMIs. The first TPMI or the one layer precoding matrix does not need to be one of a precoder in the codebooks for a UE 104, and it is only used to indicate power capability for one or more NZP ports, regardless the values of Ng or coherent capability of the UE 104.

In some examples, the second TPMI or the second precoding matrix is related to the first TPMI or the first precoding matrix. In some examples, the second TPMI or the second precoding matrix has same NZP ports as the first TPMI or the first precoding matrix. In some examples, the power capability of at least one first TPMI or first precoding matrix can be used to determine a (lowest) power/PA capability for each port, or port group. The power capability of the second TPMI can be determined based on the determined (lowest) power/PA capability for each port, or port group.

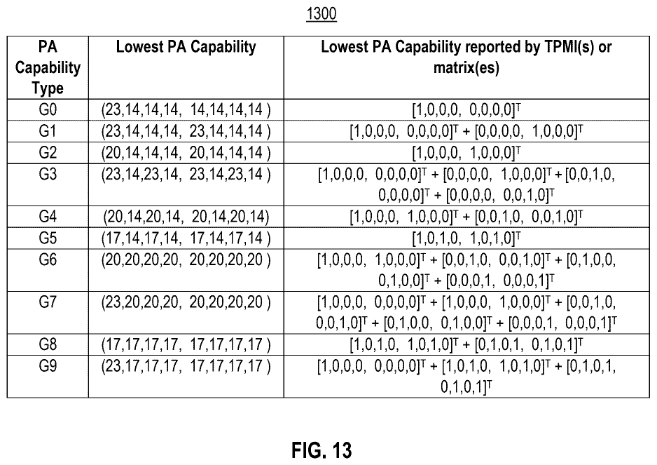

FIG. 13 is a table 1300 illustrating an example relationship between PA capability type (e.g., G0, G1, G2, G3, G4, G5, G6, G7, G8, G9, etc.), and lowest PA Capability reported by TPMI(s) or matrix(es) according to various arrangements.

In some arrangements, one of the one or more first matrices includes one layer. One of the one or more first matrices includes one column, or one row. One of the one or more first matrices includes N element(s), and each of the N elements corresponds to a respective port, N is a positive integer. One of the one or more first matrices includes at least one zero-valued element. One of the one or more first information indicates or corresponds to M port(s), Mis at least one of a positive integer or less than 8. The first information can be a bitmap that indicates one or more ports. For example, an 8-bit bitmap can indicate 1 to 7 ports, each bit corresponds to one respective port. The first information can be an index from a predetermined ports combinations list/table. In some examples, the first information can be a bitmap that indicates one or more ports. For example, an 8-bit bitmap with 1 to 7 non zero bits indicating 1 to 7 ports, each bit corresponding to one respective port. The first information can be an index from a predetermined ports combinations list/table.

In some arrangements, the second TPMI or the second precoding matrix having same NZP ports with one of the one or more first TPMIs is determined as a same power capability as for the one of the one or more first TPMIs. The second TPMI or the second precoding matrix having same NZP ports with one of the one or more first matrices is determined as a same power capability as for the one of the one or more first matrices. The second TPMI or the second precoding matrix with NZP ports is determined as a same power capability as for one of the one or more first information which indicates or corresponds to same ports as the NZP ports.

In some arrangements, the power capability report includes at least one of 1) power capability for a first port (e.g., G0), 2) the power capability for the first port and power capability for a fourth port (e.g., G1), 3) the power capability for the first port and the fourth port (e.g., G2), 4) the power capability for the first port, the power capability for a third port, power capability for a fifth port, and power capability for a seventh port (e.g., G3), 5) the power capability for the first port and the fifth port, the power capability for the third port and the seventh port (e.g., G4), 6) the power capability for the first port, the third port, the fifth port, and the seventh port (e.g., G5), 7) the power capability for the first port and the fifth port, the power capability for the second port and the sixth port, the power capability for the third port and the seventh port, and the power capability for the fourth port and the eighth port (e.g., G6), or 8) the power capability for the first port, the third port, the fifth port, and the seventh port, and the power capability for the second port, the fourth port, the sixth port, and the eighth port (e.g., G7).

In some arrangements, the scaled power of UL transmission is split among NZP ports, NZP elements, and/or MIMO layers. That is, in the method 800, at least one of the scaled power for the UL transmission is evenly split among NZP ports of the UL transmission, the scaled power for the UL transmission is evenly split among NZP elements of a precoder of the UL transmission, or the scaled power for the UL transmission is evenly split among MIMO layers of the UL transmission.

In some arrangements, the scaled power of UL transmission is evenly split among NZP ports. Further, the split power for a port is evenly split among layers in the port. That is, in the method 800, the scaled power for the UL transmission of one of the NZP ports is split evenly among layers or among NZP elements in the one of the NZP ports. In the method 800, the scaled power for the UL transmission is split evenly among the NZP elements or the or among NZP ports of each MIMO layer.

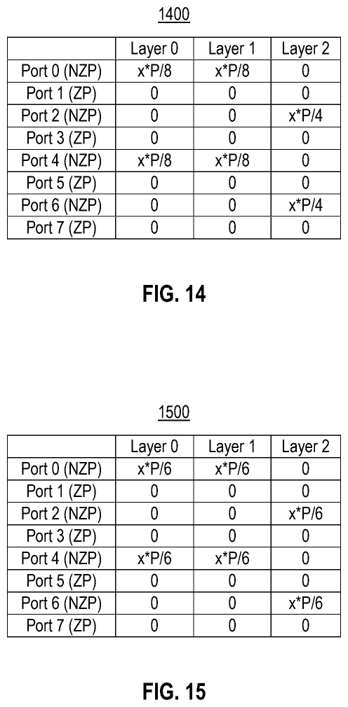

FIG. 14 is a table 1400 illustrating an example relationship between ports (ZP or NZP) and layers (e.g., layers 0, 1, and 2), according to various arrangements. The table 1400 illustrates power splitting evenly among NZP ports, then evenly splitting among layers for each port. For example, for a 8Tx PUSCH transmission as shown in table 1400, and for 4 NZP ports, the scaled power is P. Each NZP port is allocated power of P/4. Port 2 and port 6 have 1 layer, port 0 and port 4 have 2 layers. The power for an NZP element for one layer of port 2 and port 6 is P/4. The power for an element for one layer of port 0 and port 4 is P/8. P is linear scaled power value. The parameter x in table 1400, 1500 and 1600 represents an element in a precoding matrix with a module of 1, such as 1, −1, j, −j, etc.

In some arrangements, the scaled power of UL transmission is evenly split among NZP elements of the precoder. FIG. 15 is a table 1500 illustrating an example relationship between ports (ZP or NZP) and layers (e.g., layers 0, 1, and 2), according to various arrangements. The table 1500 illustrates power splitting evenly among NZP elements. For example, as shown in table 1500, there are 6 NZP elements in the precoder for a 8Tx PUSCH transmission. The power for an NZP element is P/6.

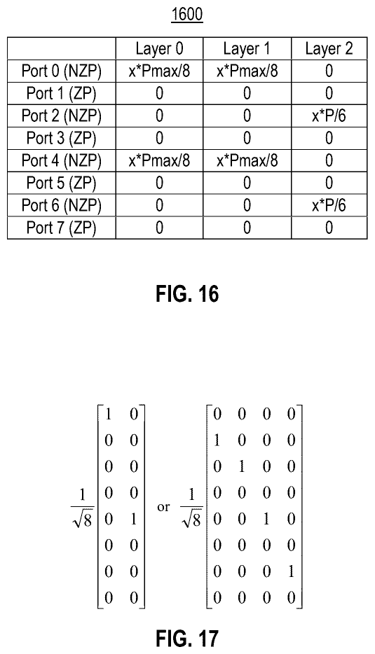

In some arrangements, the scaled power of UL transmission is evenly split among MIMO layers of the precoder. Further, the split power for a layer is evenly split among NZP ports/elements in the layer. FIG. 16 is a table 1600 illustrating an example relationship between ports (ZP or NZP) and layers (e.g., layers 0, 1, and 2), according to various arrangements. The table 1600 illustrates power splitting evenly among MIMO layers of the precoder, and the split power for a layer is evenly split among NZP ports or elements in that layer.

In the methods relative to the tables 1500 and 1600, there are 3 layers, each layer has 2 NZP elements/ports in the precoder for a 8Tx PUSCH transmission. The power for an NZP element is P/6. P is linear scaled power value.

In the methods relative to the tables 1500 and 1600, power for a first port with more layers is greater than a second port with fewer layer(s). For example, in the table 1500, port 0 with 2 layers can transmit a power of P/3, but port 2 with 1 layer may transmit a power of P/6. For 8Tx PUSCH transmission, the lowest power assumption for a port can be Pmax/8, where Pmax is the maximum power of a UE 104. If P is equal to Pmax, each NZP power is assumed to be able to transmit at most Pmax/4. However, port 0 with 2 layers may need to transmit a power of Pmax/3 which exceeds the capability of port 0 which is Pmax/4. In the examples in which P is much less than Pmax, P/3 may be less than or equal to Pmax/4, and each NZP element can have same power. This is a fair power distribution for multiple layers as compared to the method described relative to table 1400. In the method described relative to table 1400, power for a layer in a port with more layers is less than the power for a layer in a port with less layers. Thus, this may appear to be less fair from perspective of power for a layer.

Therefore, a condition may be needed for the method described relative to the table 1600.

The condition include at least one of each port can support each NZP element to be transmitted up to a power of Pmax/N or each port can support each NZP element to be transmitted up to a power of P/N. N is the number of NZP elements in the precoder.

In response to determining that such condition is not satisfied, at least one first port (power deficient port) cannot support a power of Pmax/N or P/N for each NZP elements. The power of the one first port is further scaled by a second power scaling factor to ensure the second scaled power of the first port can satisfy capability of the first port.

The capability or an adjusted capability of a first port is Pmax,p. In the example in which the first port has M layers/NZP elements, and M*P/N is larger than Pmax,p, the second power scaling factor is determined as Pmax, p divided by M*P/N.

The adjusted capability (i.e., an adjusted maximum power) of a port is determined by a minimum power capability of each port. For example, port 0 can support Pmax, port 4 can support Pmax/2. In the example in which NZP ports include port 0 and 4, then the adjusted capability of port 0 is Pmax/2. In the example in which M*P/N is greater than Pmax,p=Pmax/2, the power of M*P/N should be reduced to Pmax,p=Pmax/2. The second power scaling factor should be Pmax,p divided by M*P/N. The capability of a port can be determined for the UE 104 in a band, a Bandwidth Part (BWP), or a component carrier (CC).

In some examples, the second scaling factor is applied to the power deficient ports/the first port. In some examples, the second scaling factor is applied to other ports. For example, scale the power of the power deficient port to reach a max power of the deficient port, or to reach an adjusted max power of the deficient port. The other ports can maintain the power of M*P/N, or can be scaled by the same second power scaling factor. For example, as shown in table 1500, port 0 with 2 layers may need to transmit a power of Pmax/3 which exceeds the capability of port 0 which is Pmax/4. The second power scaling factor is needed for port 0 and 4. Power of port 0/4 is reduced to Pmax/4, and power of each layer for port 0/4 can be P/8. The second power scaling factor can be 3Pmax/4P. In some examples, the second power scaling factor can be applied to NZP element for port 2 or port 4, e.g., Pmax/8, or is not applied, and the power for NZP element for port 2 or 4 can remain P/6.

In some arrangements, in the method 800, the power for the uplink transmission is split among the NZP elements, or the MIMO layers in response to determining that the UE 104 supports splitting the scaled power for the uplink transmission among the NZP elements, or the MIMO layers. In some arrangements, in response to determining that a power capability of a port, a port group, or a set of ports of the wireless communication device does not support splitting the scaled power among the NZP elements, or the MIMO layers, scaling a power for the port to reach a maximum power of the port or an adjusted maximum power of the port and determining a second scaling factor.

In some arrangements, in the method 800, the UE 104 further determines a second scaling factor for the port with a power capability less than a split scaled power for the port, the second scaling factor is configured to meet the power capability of the port. In some arrangements, in the method 800, the UE 104 applies the second scaling factor to scale the power for other ports from the port. In some arrangements, in the method 800, the UE 104 applies the second scaling factor to scale the power for the port or applies the second scaling factor to all of the ports of the UE 104. In some arrangements, applying a second scaling factor for a port includes a power of a port is adjusted to be the scaled power of the port multiplied by the second scaling factor.

In some arrangements, the UE 104 can determine a coefficient of precoding matrix for partial coherent and non-coherent codebooks. In some arrangements, a coefficient of the precoder is determined based on at least one of a number of NZP elements of the precoder, a number of NZP ports of the precoder, or a number of layers of the precoder.

For example, a precoding matrix for non-coherent 8Tx (8-port) with Ng=8 is determined by 1 to 8 unit vectors. The coefficient can be 1/\sqrt{8}. This can ensure power of each port is not beyond the PA capability of each port. The precoding matrix can be determined based on the most conservative assumption, e.g., one port can support up to ⅛ of maximum power of the UE 104. An example of the precoding matrix with the coefficient of 1/\sqrt{8} is shown in FIG. 17.

Precoding matrix for partial coherent 8Tx (8-port) with Ng=2 is determined by 1 or 2 4Tx TPMIs. The 2 4Tx precoding matrices correspond to 2 number of layers, e.g., L1 and L2 respectively, where L1 or L2 is an integer, and 0<=(L1, or L2)<=4.

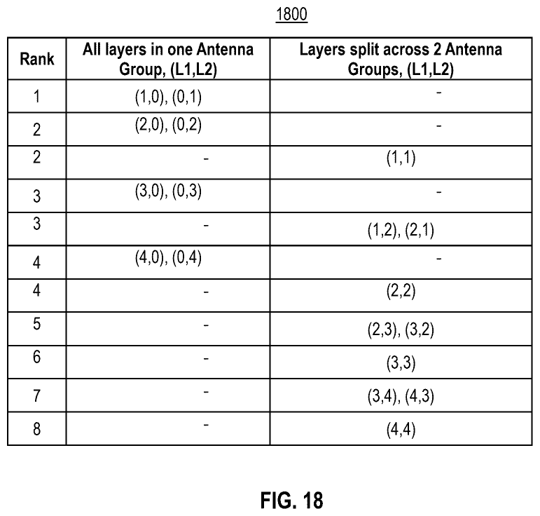

In order to reduce number of codebooks, in some arrangements, not all value combinations for L1 and L2 are allowable. FIG. 18 is a table 1800 that illustrates example relationships between the rank, values of (L1, L2) for all layers in an antenna group, and values of (L1, L2) for layers split across 2 antenna groups, according to some arrangements.

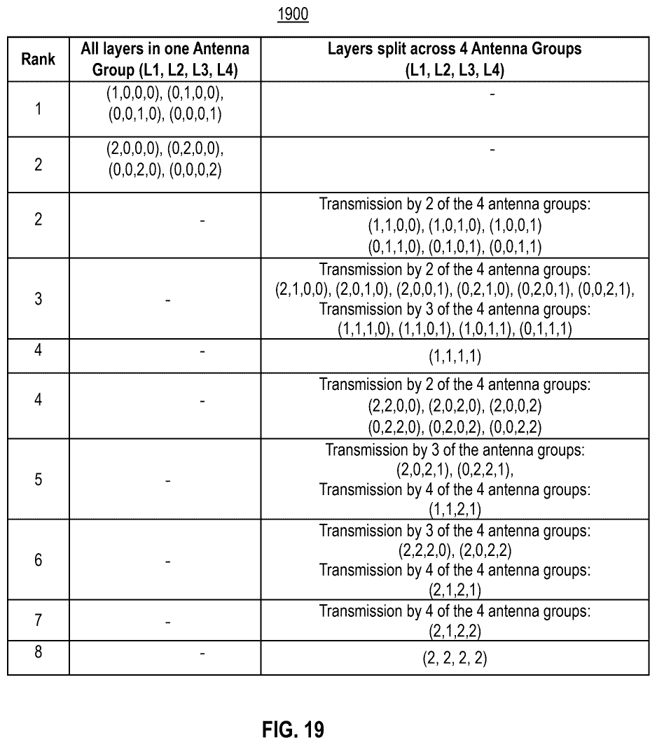

Similarly, a precoding matrix for partial coherent 8Tx (8-port) with Ng=4 is determined by 1 to 4 2Tx TPMIs, and the 4 2Tx precoding matrices correspond to 4 numbers of layers, e.g., L1, L2, L3 and L4 respectively, where L1, L2, L3, or L4 is an integer, and 0<=(L1, L2, L3, or L4)<=2. In order to reduce number of codebooks, not all value combinations for L1, L2, L3, or L4 are allowable. FIG. 19 is a table 1900 that illustrates example relationships between the rank, values of (L1, L2, L3, L4) for all layers in an antenna group, and values of (L1, L2, L3, L4) for layers split across 4 antenna groups, according to some arrangements.

In some examples, the precoding matrix for 8Tx can be determined according to 2 4Tx precoding matrix.

In some examples, the UE 104 can determine coefficient of 8Tx precoding matrix using the coefficient of 4Tx or 2Tx precoding matrix. For example, the coefficient of 4Tx (or 2Tx) precoding matrix is used to determine coefficient of 8Tx precoding matrix, and a product of a factor 1/\sqrt{N_{g}} times the coefficient of each element of 4Tx (or 2Tx) precoding matrix can be the coefficient of the corresponding element of 8Tx precoding matrix.

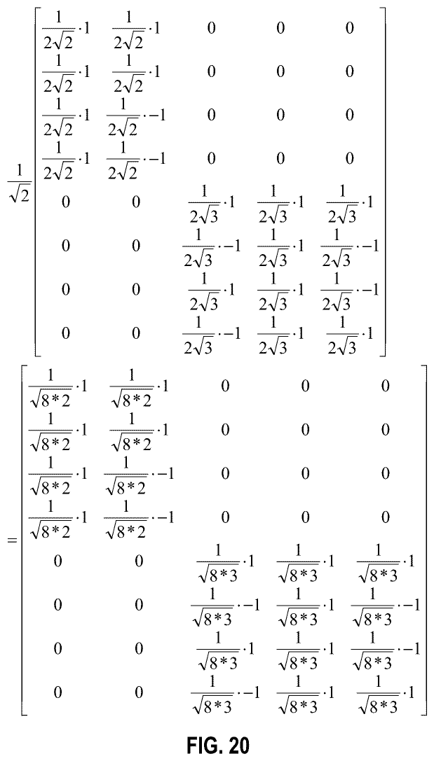

For example, FIG. 20 illustrates a 2 layers 4Tx precoding matrix and a 3 layers 4Tx precoding matrix with coefficient with a factor 1/\sqrt{N_{g}} used to determine a precoding matrix for 8Tx, according to various arrangements. In FIG. 20, Ng=2.

As illustrated in FIG. 20, the mapping order of [first 4Tx group: port 0, 1, 2, 3] [second 4Tx group: port 0, 1, 2, 3] mapping to [8Tx port 0, 1, 2, 3, 4, 5, 6, 7] respectively is used. Port index mapping between 2 4Tx ports and 8Tx ports can be in another order, e.g., [first 4Tx group: port 0, 1, 2, 3] [second 4Tx group: port 0, 1, 2, 3] mapping to [8Tx port 0, 1, 4, 5, 2, 3, 6, 7] respectively, or [first 4Tx group: port 0, 1, 2, 3] [second 4Tx group: port 0, 1, 2, 3] mapping to [8Tx port 0, 2, 4, 6, 1, 3, 5, 7] respectively.

In some examples, the UE 104 can determine the coefficient of 8Tx precoding matrix without using the coefficient of 4Tx (or 2Tx) precoding matrix. For example, the coefficient of 4Tx (or 2Tx) precoding matrix is not used to determine coefficient of 8Tx precoding matrix. Only elements or 4Tx (or 2Tx) precoding matrix without its own coefficient, such as 1, −1, j, or −j, and a (new) uniform coefficient X is used to determine 8Tx precoding matrix.

In some arrangements, the uniform coefficient X is determined by 1/\sqrt{N_{NZP}}. N_{NZP} is the number of NZP elements in 8Tx precoding matrix, or in the 1 or 2 4Tx precoding matrices. FIG. 21 is an 8Tx precoding matrix using a uniform coefficient determined by N_{NZP}=2, according to some arrangements.

Accordingly, the precoding matrix can be normalized. The ports with larger number of layers may be allocated to higher power than the ports with smaller number of layers. When the required transmit power is near the maximum power, the power of ports of larger number of layers may become the bottleneck, i.e., the required power for the port is larger than PA capability of the port. In order to address this issue, a lower coefficient as follows can be determined.

In some arrangements, the uniform coefficient X is determined by 1/\sqrt{8*Lₘₐₓ}. Lₘₐₓ is the maximum number of layers of each port groups, e.g., maximum number between L1 and L2 for the 2 4Tx precoding matrices, or a maximum number between L1, L2, L3 and L4 for the 4 2Tx precoding matrices. If there is only one 4Tx precoding matrix corresponding to the first or the second 4Tx precoding matrix, the other precoding matrix does not exist, and the corresponding number of layers L2 or L1 is 0. In some examples, the value 8 in 1/\sqrt{8*Lₘₐₓ} can be replaced by another value if the number of ports for the precoding matrix is the another value. In the example in which L1=2, L2=3, Lₘₐₓ=3, coefficient for the elements in 8Tx precoding matrix is

$$\frac{1}{\sqrt{8 * 3}} .$$

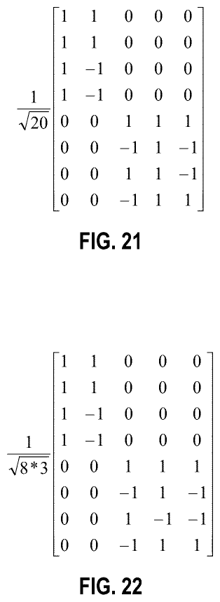

FIG. 22 is an 8Tx precoding matrix using a uniform coefficient determined by Lₘₐₓ=3, according to some arrangements.

In some examples, coefficient of an element is determined according to at least one of a number of all ports, a number of NZP ports, or a number of layers of a port (i.e., a number of NZP elements for a port).

For example, the coefficient of an element can determined according to at least one of 1) the power ratio among ports are the same, 2) the elements of a port group have same coefficient, or 3) the elements of different port groups corresponding to different layers have different coefficients.

In some arrangements, in the method 800, a power portion among ports of the precoder are same. Elements of a port group of the precoder have a same coefficient. Elements of different port groups corresponding to different layers have different coefficients. In some examples, the power portion of one port is determined according to coefficients of NZP elements/layers of the port. Further, the power portion of one port is determined as sum of square of each coefficient of NZP elements/layers of the port. In the examples in which there are 4 elements for a port, including 2 NZP elements, each port has a coefficient of ¼, and the power portion can be determined as (¼)²+(¼)²=⅛. A product of 1/\sqrt{N_{g}} times the coefficient of each element of 4Tx or 2Tx precoding matrix is determined as a coefficient of the corresponding element of 8Tx precoding matrix, where Ng is the number of port groups corresponding to the uplink transmission.

In some arrangements, the coefficient of an element is determined according to at least one of 1) a power ratio among layers or among NZP elements are the same, 2) elements of all NZP elements have same coefficient, 3) 1/\sqrt{N_{NZP}}, where N_{NZP} is the number of NZP elements in 8Tx precoding matrix, or 4) 1/\sqrt{8*Lₘₐₓ}, and Lₘₐₓ is the maximum number of layers of each port group.

In some arrangements, in the method 800, a power portion among layers of the precoder are same. Elements of all NZP elements of the precoder have a same coefficient. The power portion of one layer is determined according to coefficients of NZP elements/ports of the layer. Further, the power portion of one layer is determined as sum of square of each coefficient of NZP elements/ports of the layer. In the example in which there are 8 elements for a layer, including 2 NZP elements, each with a coefficient of ¼, then the portion can be determined as (¼)²+ (¼)²=⅛.

In some arrangements, in the method 800, the coefficient is defined by 1/N_Element (e.g., 1/\sqrt{N_{NZP}}). N_element is a number of all NZP elements of the precoder.

In some arrangements, in the method 800, the coefficient of an NZP element is a minimum of 1/sqrt(N*Mp) among all NZP ports of the precoder. Mp is a number of layers for port p or a number of NZP elements for port p. N is a number of NZP ports.

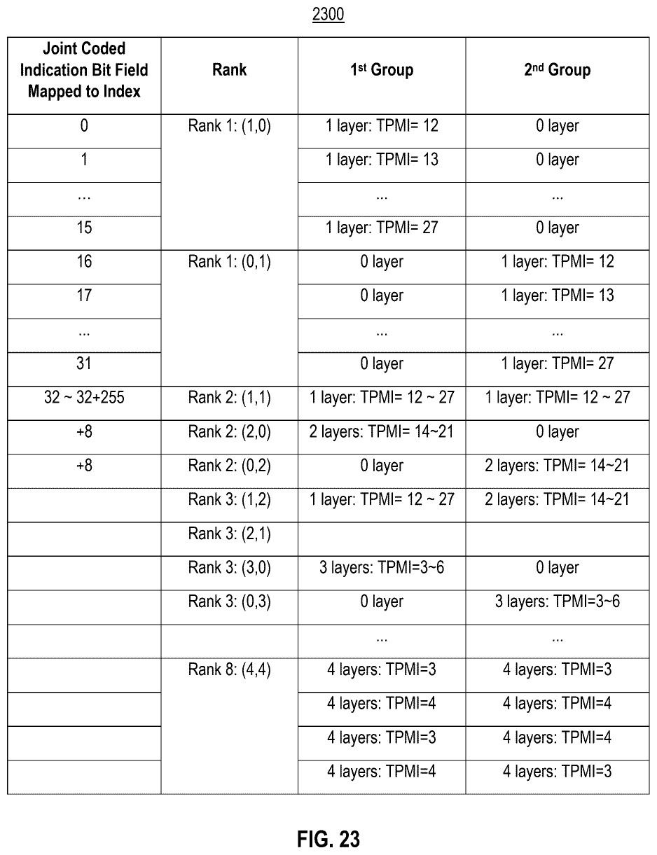

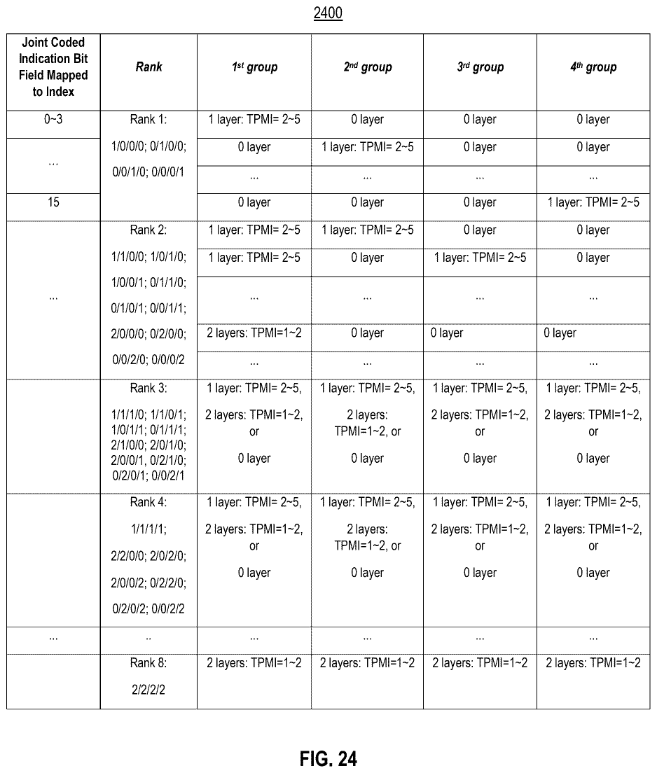

In some arrangements, the UE 104 determines a precoder for a UL transmission according to at least one of: Ng, coherent level, codebooktype, maxRank, or TPMI information. In some arrangements, the TPMI information includes one field value indicating a rank value and a 8Tx precoding matrix. In some arrangements, the TPMI information includes Ng rank value(s) and corresponding Ng 8/Ng Tx TPMI(s). In some arrangements, the TPMI information includes one field value indicating Ng rank value(s) and corresponding Ng 8/Ng Tx TPMI(s). For example, FIG. 23 is a table 2300 illustrating an example relationship between joint coded indication bit field mapped to indices, rank (rank restriction), a first port group, and a second port group. FIG. 24 is a table 2400 illustrating an example relationship between joint coded indication bit field mapped to indices, rank (rank restriction), a first port group, a second port group, a third port group, and a fourth port group.

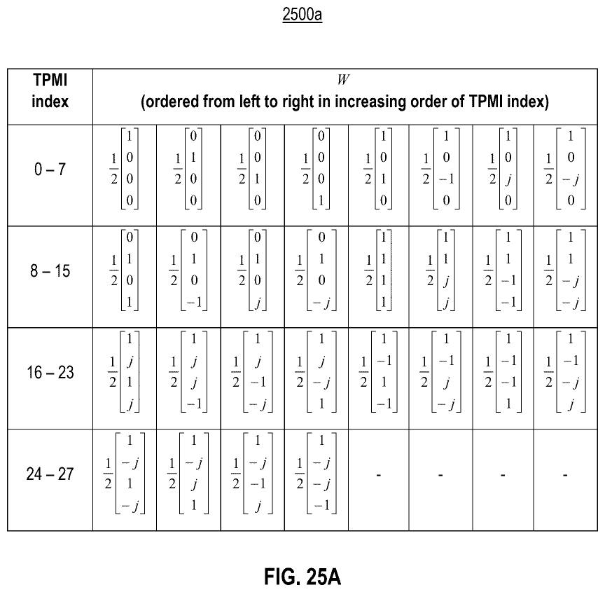

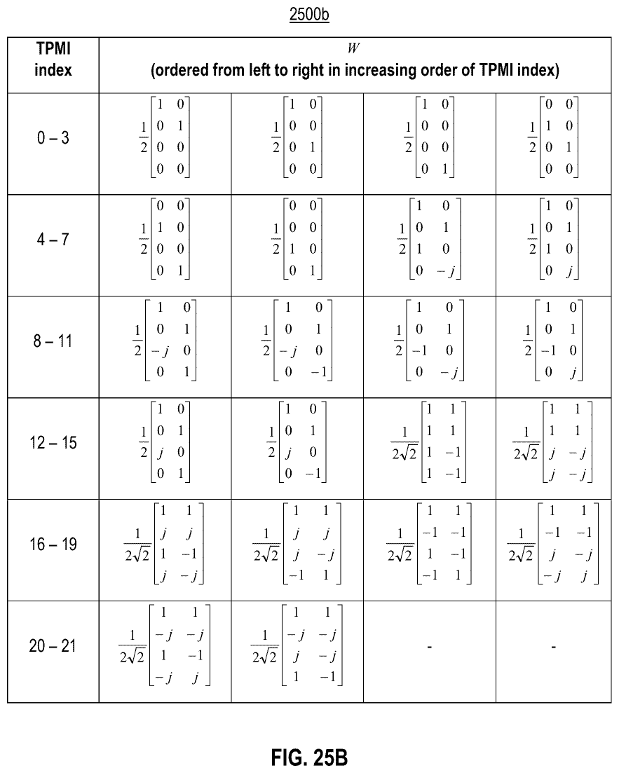

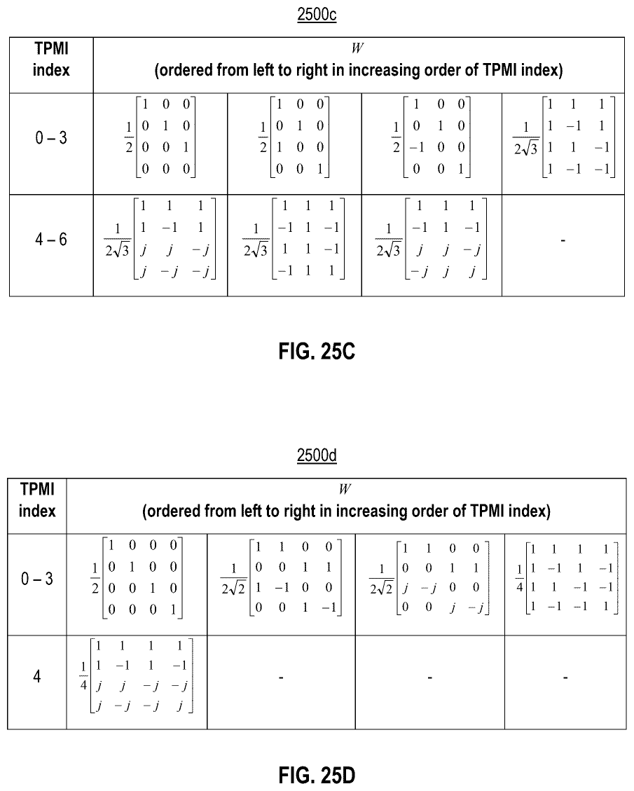

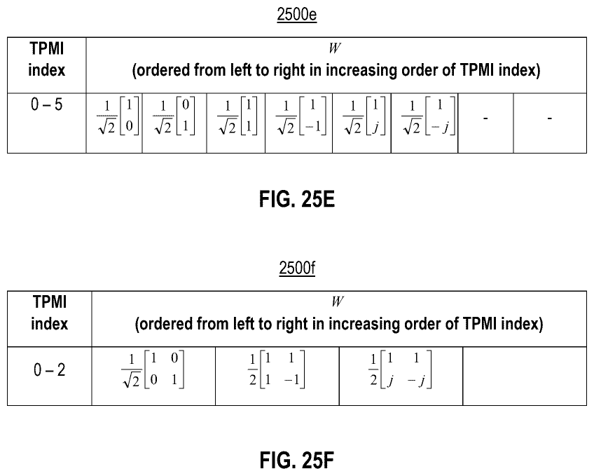

The predefined precoder sets for UL 4Tx and UL 2Tx for rank 1-4 and rank 1-2 are shown in tables of FIGS. 25A, 25B, 25C, 25D, 25E, and 25F, respectively.

FIG. 25A is a table 2500a illustrating a precoding matrix W for single-layer transmission using four antenna ports with transform precoding disabled, according to some arrangements. FIG. 25B is a table 2500b illustrating a precoding matrix W for two-layer transmission using four antenna ports with transform precoding disabled, according to some arrangements. FIG. 25C is a table 2500c illustrating a precoding matrix W for three-layer transmission using four antenna ports with transform precoding disabled, according to some arrangements. FIG. 25D is a table 2500d illustrating a precoding matrix W for four-layer transmission using four antenna ports with transform precoding disabled, according to some arrangements. FIG. 25E is a table 2500e illustrating a precoding matrix W for single-layer transmission using two antenna ports, according to some arrangements. FIG. 25F is a table 2500f illustrating a precoding matrix W for two-layer transmission using two antenna ports with transform precoding disabled, according to some arrangements.

While various arrangements of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one arrangement can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
determining, by a wireless communication device, a precoder for an uplink transmission;
determining, by a wireless communication device, power for the uplink transmission according to a scaling factor, wherein the scaling factor is determined according to a power capability report;
sending, by a wireless communication device to a network, the uplink transmission according to the precoder and the power for the uplink transmission; and
determining, by a wireless communication device, a coefficient of an element of the precoder which is an 8-port precoding matrix, according to a product of 1/\sqrt{N_{g}} and a coefficient of each element of a corresponding 4-port or 2-port precoding matrix, where Ng is a number of port groups corresponding to the uplink transmission.

2. The wireless communication method of claim 1, further comprising determining, by the wireless communication device, a scaled power for the uplink transmission by applying a scaling factor to a linear power of the uplink transmission.

3. The wireless communication method of claim 1, wherein the scaling factor comprises at least one of:
1; or
N1/N,
wherein N1 is a number of Non-Zero-Power (NZP) ports of the uplink transmission, and N is a number of ports of the wireless communication device used for the uplink transmission.

4. The wireless communication method of claim 1, wherein
the power capability report is sent by the wireless communication device to the network; or
the power capability report comprises power capability for full power mode 2.

5. The wireless communication method of claim 1, wherein the power capability report comprises power capability for one or more ports or one or more port groups, of the wireless communication device.

6. The wireless communication method of claim 1, wherein the power capability report comprises power capability of full power.

7. The wireless communication method of claim 1, wherein
the power capability report comprises power capability for at least one of one or more first Transmitted Precoding Matrix Indicator (TPMI), one or more first matrices, or one or more first information; and
the wireless communication device determines power capability for at least one of a second TPMI or a second precoding matrix according to the at least one of the one or more first TPMI, the one or more first matrices, or the one or more first information.

8. The wireless communication method of claim 7, wherein one of the one or more first information corresponds to M port(s), wherein Mis at least one of a positive integer or is less than 8.

9. The wireless communication method of claim 7, wherein
the second TPMI or the second precoding matrix having same NZP ports with one of the one or more first TPMIs is determined as a same power capability as for the one of the one or more first TPMIs;
the second TPMI or the second precoding matrix having same NZP ports with one of the one or more first matrices is determined as a same power capability as for the one of the one or more first matrices;
the second TPMI or the second precoding matrix with NZP ports is determined as a same power capability as for one of the one or more first information which indicates or corresponds to same ports as the NZP ports.

10. The wireless communication method of claim 1, wherein the power capability report is determined according to a number of port groups.

11. The wireless communication method of claim 10, wherein the number of port groups is a number of port groups configured or indicated by the network to the wireless communication device.

12. The wireless communication method of claim 10, further comprising:
the power capability report comprises power capability for at least one of one or more first Transmitted Precoding Matrix Indicator (TPMI), one or more first matrices, or one or more first information, according to the number of port groups.

13. The wireless communication method of claim 10, wherein:
the number of port groups is 2, the power capability report comprises at least one of:
power capability for a first port group; or
power capability for a second port group.

14. The wireless communication method of claim 1, wherein, a coefficient of the precoder is determined based on at least one of a number of Non-Zero-Power (NZP) elements of the precoder, a number of NZP ports of the precoder, or a number of layers of the precoder.

15. The wireless communication method of claim 14, wherein at least one of:
a power portion among ports of the precoder are same; or
elements of a port group of the precoder have a same coefficient.

16. The wireless communication method of claim 14, wherein at least one of:
a power portion among layers of the precoder are same;
elements of all NZP elements of the precoder have a same coefficient; or
the coefficient is determined as 1/N_Element, wherein N_element is a number of all NZP elements of the precoder.

17. The wireless communication method of claim 14, wherein
the coefficient of an NZP element is a minimum of 1/sqrt(N*Mp) among all NZP ports of the precoder;
wherein Mp is a number of layers for port p, or a number of NZP elements for port p; and Nis a number of NZP ports.

18. A wireless communication device, comprising:
at least one processor configured to:
determine a precoder for an uplink transmission;
determine power for the uplink transmission according to a scaling factor, wherein the scaling factor is determined according to a power capability report;
send, via a transmitter to a network, the uplink transmission according to the precoder and the power for the uplink transmission; and
determine a coefficient of an element of the precoder which is an 8-port precoding matrix, according to a product of 1/\sqrt{N_{g}} times a coefficient of each element of a corresponding 4-port or 2-port precoding matrix, where Ng is a number of port groups corresponding to the uplink transmission.

19. A wireless communication method, comprising:
receiving, by a network from a wireless communication device, an uplink transmission, wherein the uplink transmission is transmitted using a precoder and a power determined by the wireless communication device according to a scaling factor, the scaling factor determined according to a power capability report,
wherein a coefficient of an element of the precoder which is an 8-port precoding matrix, is determined according to a product of 1/\sqrt{N_{g}} and a coefficient of each element of a corresponding 4-port or 2-port precoding matrix, where Ng is a number of port groups corresponding to the uplink transmission.

20. A network device, comprising:
at least one processor configured to:
receive, via a receiver from a wireless communication device, an uplink transmission, wherein the uplink transmission is transmitted using a precoder and a power determined by the wireless communication device according to a scaling factor, the scaling factor determined according to a power capability report,
wherein a coefficient of an element of the precoder which is an 8-port precoding matrix, is determined according to a product of 1/\sqrt{N_{g}} and a coefficient of each element of a corresponding 4-port or 2-port precoding matrix, where Ng is a number of port groups corresponding to the uplink transmission.
